(19) United States
(12) Patent Application Publication
(10) Pub. No.: US 2014/0144581 A1
(43) Pub. Date: May 29, 2014

(54) METHOD FOR MANUFACTURING A MAGNET-CONDUCTIVE DEVICE AND APPARATUS THEREOF

(71) Applicant: METAL INDUSTRIES RESEARCH & DEVELOPMENT CENTRE, Kaohsiung City (TW)

(72) Inventors: Kuo-Yin Tu, Kaohsiung City (TW); Hsing-Chih Tsai, Kaohsiung City (TW); Hsin-Te Wang, Kaohsiung City (TW); Pin-Jyun Chen, Kaohsiung City (TW); Chih-Hao Lin, Kaohsiung City (TW); Po-Fu Hsu, Kaohsiung City (TW); Ching-Hua Hsieh, Kaohsiung City (TW)

(73) Assignee: METAL INDUSTRIES RESEARCH & DEVELOPMENT CENTRE, Kaohsiung City (TW)

(21) Appl. No.: 14/055,342

(22) Filed: Oct. 16, 2013

(30) Foreign Application Priority Data
Nov. 29, 2012 (TW) 101144729

(51) Int. Cl. H01F 41/00

(52) U.S. Cl. CPC H01F 41/00
USPC 156/247; 156/60; 156/580

(57) ABSTRACT

A method for manufacturing magnet-conductive device includes a filling step and an adhering step. The filling step includes providing a glue by a glue dispenser and contacting the glue with a first magnet-conductive plate to make the glue adhered to a lower surface of the first magnet-conductive plate. The adhering step includes making the lower surface of the first magnet-conductive plate face toward a second magnet-conductive plate, making the first magnet-conductive plate and the second magnet-conductive plate stackable from each other and adhering the first magnet-conductive plate and the second magnet-conductive plate via the glue. Eventually, by repeatedly performing the filling step and the adhering step, the desirable stacking quantity is achieved to form a magnet-conductive device.

### FIELD OF THE INVENTION

The present invention is generally related to a method for manufacturing a magnet-conductive device. Particularly, the manufacturing method enables plural magnet-conductive plates to be stacked and adhered from each other by means of a glue dispenser and a stamping unit therefore forming the magnet-conductive device.

### BACKGROUND OF THE INVENTION

A conventional method for manufacturing a magnet-conductive device is to form plural protrusions or bumps on an upper surface of each of plural silicon steel sheets and to form plural slots at a lower surface of each of the silicon steel sheets by punching process. Eventually, to engage adjacent silicon steel sheets by riveting process therefore forming the magnet-conductive device. However, the magnet-conductive device manufactured by mentioned riveting process generates iron loss, burr eddy-current loss and short issues. Additionally, a large gap is formed between adjacent silicon steel sheets. When the magnet-conductive device is applicable to a motor and the motor is in operation, the gap between adjacent silicon steel sheets results in vibrations and sounds of wind shear.

### SUMMARY

The primary object of the present invention is to provide a method for manufacturing a magnet-conductive device and an apparatus thereof. By utilizing a glue dispenser and a stamping unit of the apparatus for manufacturing the magnet-conductive device, adjacent magnet-conductive plates enable to be mutually adhered and stackable to form the magnet-conductive device for prevention of iron loss, burr eddy-current loss and short phenomenon. Besides, when the present invention is applicable to a motor, wind shear phenomenon is avoidable so as to prevent vibrations and sounds of wind shear.

The method for manufacturing the magnet-conductive device includes a filling step and an adhering step. The filling step includes providing a glue by a glue dispenser, wherein the glue dispenser comprises a base having a top surface and a plurality of glue outlets located on the top surface, the glue is transmitted to the glue outlets and protrudes to the top surface of the base. The filling step also includes contacting the glue with a first magnet-conductive plate, wherein the first magnet-conductive plate comprises an upper surface and a lower surface facing toward and contacting with the glue to make the glue adhered to the lower surface of the first magnet-conductive plate. The adhering step includes making the lower surface of the first magnet-conductive plate face toward a second magnet-conductive plate and stamping the first magnet-conductive plate and the second magnet-conductive plate to make the first magnet-conductive plate adhered to the second magnet-conductive plate via the glue.

In this invention, the filling step is to provide the glue by the glue dispenser and make the glue adhered to the first magnet-conductive plate, and the adhering step is to make the glue adhered to the first magnet-conductive plate and the second magnet-conductive plate so that the gap between the first magnet-conductive plate and the second magnet-conductive plate is filled with the glue. By repeatedly performing the filling step and the adhering step, the desired stacking quantity is achieved to form the magnet-conductive device. In this invention, the first magnet-conductive plate and the second magnet-conductive plate are mutually coupled by means of pressure from the stamping unit and adherence of the glue. Therefore, the gap between the first magnet-conductive plate and the second magnet-conductive plate in the present invention is relatively smaller than that by using riveting process. The present invention enables to shorten current path, decrease ion loss and increase flux density. Additionally, the first magnet-conductive plate and the second magnet-conductive plate are spaced apart by the glue so that short issue is prevented and burr eddy-current loss is decreased. Furthermore, when the magnet-conductive device is applicable to a motor and the motor is in operation, owing to the reason that the gap between the first magnet-conductive plate and the second magnet-conductive plate is filled with the glue, the wind shear phenomenon is eliminated to prevent vibrations and sounds of wind shear.

DESCRIPTION OF THE DRAWINGS

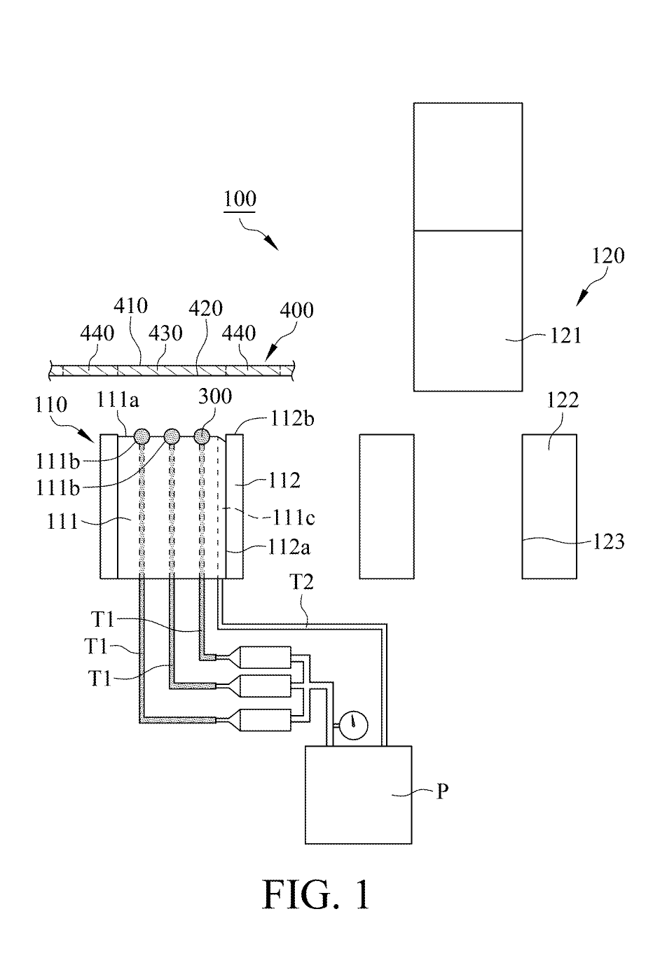

FIG. 1 is a schematic diagram illustrating an apparatus for manufacturing a magnet-conductive device in accordance with an embodiment of the present invention.

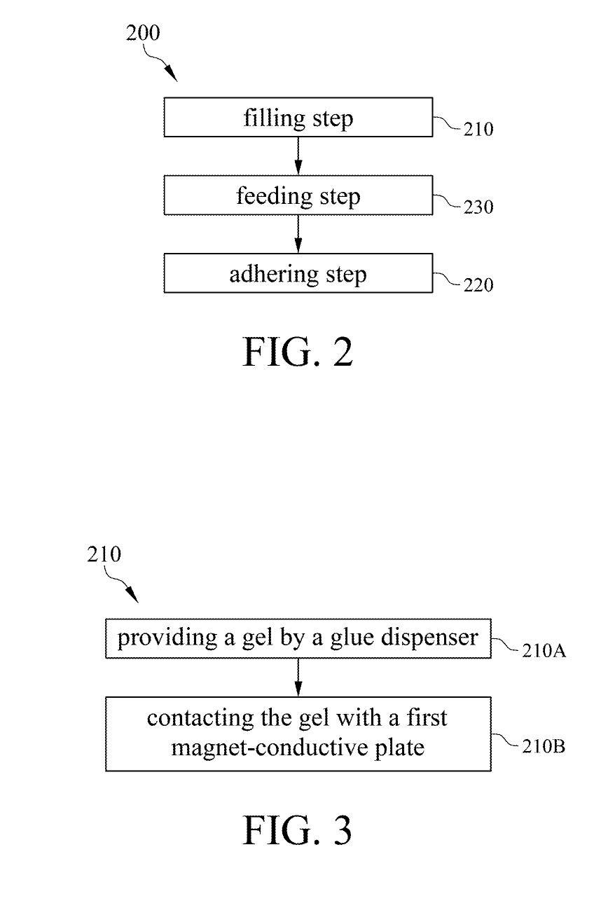

FIG. 2 is a flow chart illustrating a method for manufacturing the magnet-conductive device in accordance with the embodiment of the present invention.

FIG. 3 is a flow chart illustrating a filling step of the method for manufacturing the magnet-conductive device in accordance with the embodiment of the present invention.

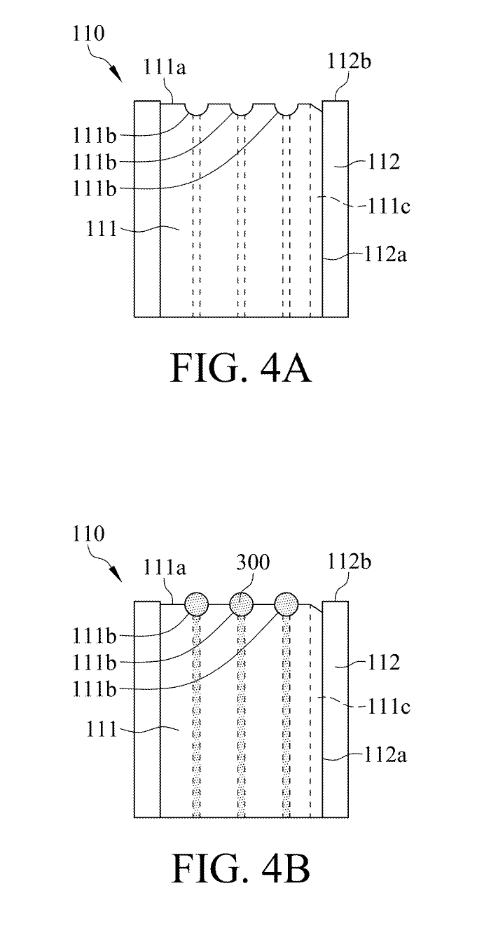

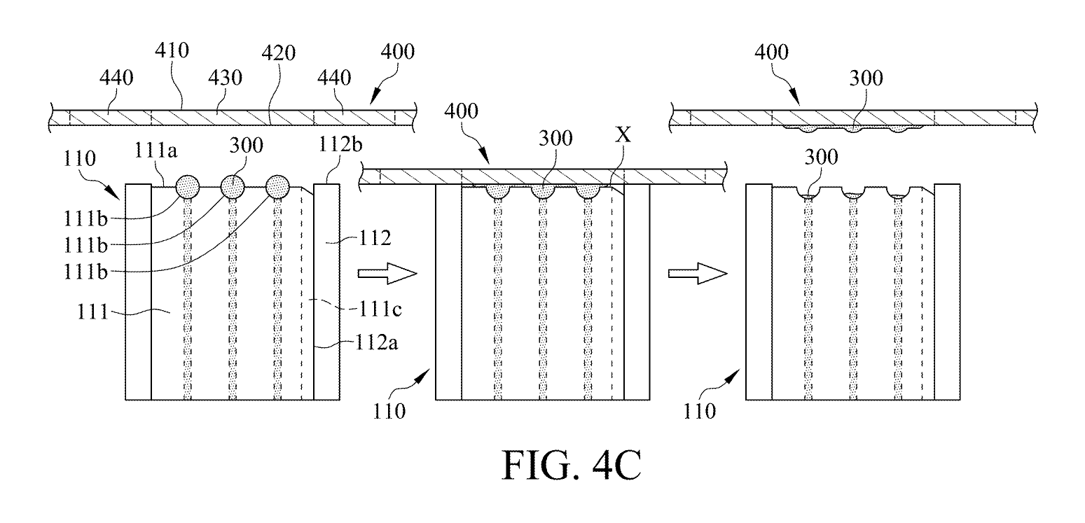

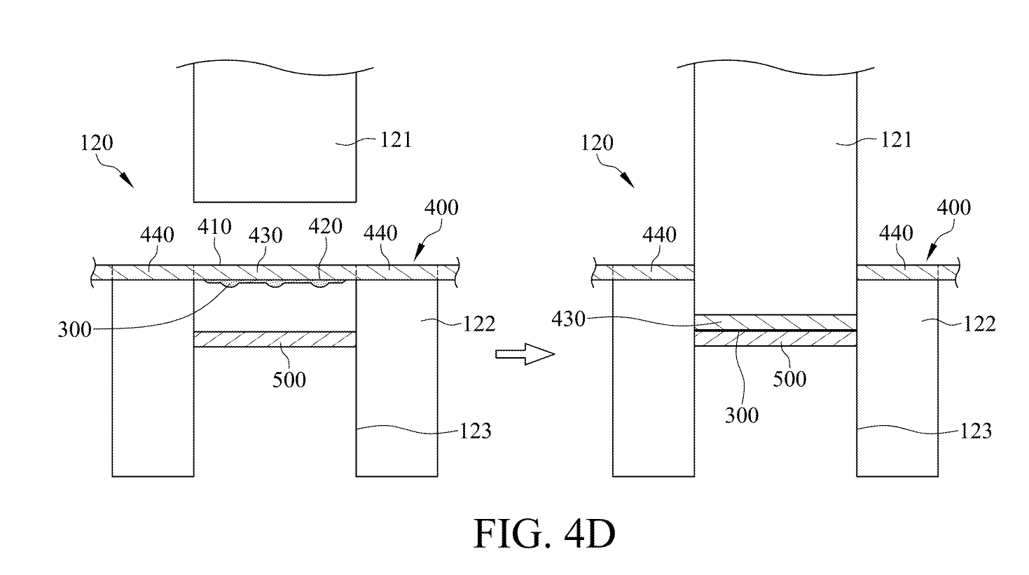

FIGS. 4A to 4D are schematic diagrams illustrating the manufacturing method and an apparatus for manufacturing the magnet-conductive device in accordance with the embodiment of the present invention.

### DETAILED DESCRIPTION OF THE INVENTION

With reference to FIG. 1, an apparatus 100 for manufacturing a magnet-conductive device in accordance with a preferred embodiment of the present invention includes a glue dispenser 110 and a stamping unit 120. Please refer to FIG. 2, a method 200 for manufacturing the magnet-conductive device includes a filling step 210 and an adhering step 220.

Please refer to FIGS. 2 and 3, wherein the filling step 210 includes a first sub-step 210A of providing a glue by a glue dispenser and a second sub-step 210B of contacting the glue with a first magnet-conductive plate.

Please refer to FIGS. 1, 2, 3 and 4A, wherein in the first sub-step 210A of providing the glue by the glue dispenser, the glue dispenser 110 includes a base 111 and a substrate 112. Or, in another embodiment, the glue dispenser 110 merely possesses the base 111. In this embodiment, the substrate 112 comprises an accommodating slot 112a and a bearing surface 112b, the accommodating slot 112a is recessed to the bearing surface 112b, or the accommodating slot 112a enables to penetrate through the substrate 112, and the base 111 is disposed into the accommodating slot 112a of the substrate 112. The base 111 comprises a top surface 111a and a plurality of glue outlets 111b located at the top surface 111a, and the bearing surface 112b of the substrate 112 is higher than the top surface 111a of the base 111.

With reference to FIGS. 1 and 4B, in this embodiment, a glue 300 is transmitted to the glue outlets 111b by a pump P and a plurality of injection tubes T1 connected to the pump P and the base 111. The glue 300 enables to protrude from the top surface 111a of the base 111, preferably, the glue 300 is higher than the bearing surface 112b of the substrate 112.

Next, refer to FIGS. 1, 3 and 4C, wherein in the second sub-step 210B of contacting the glue with a first magnet-conductive plate, the first magnet-conductive plate 400 comprises an upper surface 410 and a lower surface 420 facing toward and contacting with the glue 300 for making the glue 300 adhered to the lower surface 420 of the first magnet-conductive plate 400.

With reference to FIGS. 1 and 4C, in this embodiment, the first magnet-conductive plate 400 comprises a bearing portion 430 and a pre-moved portion 440 located at outside of the bearing portion 430. In the second sub-step 210B of contacting the glue with the first magnet-conductive plate, the bearing portion 430 corresponds to the top surface 111a of the base 111, and the pre-moved portion 440 corresponds to the bearing surface 112b of the substrate 112. When the lower surface 420 of the first magnet-conductive plate 400 contacts with the glue 300, owing to the bearing surface 112b of the substrate 112 higher than the top surface 111a of the base 111, the pre-moved portion 440 contacts with the bearing surface 112b of the substrate 112 to make the bearing portion 430 and the top surface 111a of the base 111 spaced apart from each other therefore defining a gap X. The glue volume for the glue 300 adhered to the bearing portion 430 is controllable via the gap X so as to prevent the glue 300 from excessively adhering to the first magnet-conductive plate 400 therefore eliminating the occurrence of glue spill or glue leakage in the adhering step 220. With reference to FIG. 4C, in this embodiment, the glue 300 is attached to the bearing portion 430 of the first magnet-conductive plate 400.

With reference to FIGS. 1 and 4C, in this embodiment, the glue dispenser 110 further comprises a suction hole 111c located at the top surface 111a of the base 111. When the lower surface 420 of the first magnet-conductive plate 400 contacts with the glue 300, the glue 300 will be extruded to spread toward the top surface 111a of the base 111. The glue 300 spreading over the top surface 111a can be absorbed and removed by the suction hole 111c through the pump P and a tube T2 connected to the pump P and the base 111 to prevent dirt of the base 111, or to prevent glue spill or glue leakage due to an excess of glue volume in the next filling step.

With reference to FIGS. 1, 2 and 4D, wherein the adhering step 220 includes making the lower surface 420 of the first magnet-conductive plate 400 face toward a second magnet-conductive plate 500 and stamping the first magnet-conductive plate 400 and the second magnet-conductive plate 500 to make the first magnet-conductive plate adhered to the second magnet-conductive plate via the glue. In this embodiment, the first magnet-conductive plate 400 is stamped by the stamping unit 120, and then the first magnet-conductive plate 400 is adhered to the second magnet-conductive plate 500. The stamping unit 120 includes a stamping member 121 and a molding base 122 having a cavity 123, wherein in the adhering step 220, the bearing portion 430 of the first magnet-conductive plate 400 is stamped by the stamping member 121 of the stamping unit 120 to make the bearing portion 430 separate apart from the pre-moved portion 440 and fall into the cavity 123 of the molding base 122 therefore adhering to the second magnet-conductive plate 500.

The method for manufacturing the magnet-conductive device further includes a feeding step 230 performed between the filling step 210 and the adhering step 220, wherein the feeding step 230 includes transmitting the first magnet-conductive plate 400 with the adhering glue 300 from the glue dispenser 110 to the stamping unit 120 by a feeder (not shown in Figs.) for performing the following adhering step 220.

With reference to FIGS. 1, 2 and 4A to 4D, repeatedly performing the filling step 210 and the adhering step 220 to make plural magnet-conductive plates to be stackable, and make adjacent magnet-conductive plates adhered to each other by the glue 300 to form a magnet-conductive device (such as a stator). In this invention, adjacent magnet-conductive plates are adhered by the glue 300 so that the issues of iron loss, burr eddy-current loss and short phenomenon can be effectively eliminated. Additionally, when the present invention is applicable to a motor, owing to the gap between adjacent magnet-conductive plates filled with the glue 300, the wind shear phenomenon is eliminated to prevent vibrations and sounds of wind shear.

While this invention has been particularly illustrated and described in detail with respect to the preferred embodiments thereof, it will be clearly understood by those skilled in the art that it is not limited to the specific features and describes and various modifications and changes in form and details may be made without departing from the spirit and scope of this invention.

What is claimed is:

1. A method for manufacturing a magnet-conductive device including:
a filling step includes:
providing a glue by a glue dispenser having a base, the base comprises a top surface and a plurality of glue outlets located on the top surface, the glue is transmitted to the glue outlets and protrudes to the top surface of the base; and
contacting the glue with a first magnet-conductive plate having an upper surface and a lower surface, the lower surface faces toward and contacts with the glue to make the glue adhered to the lower surface of the first magnet-conductive plate; and
an adhering step includes:
making the lower surface of the first magnet-conductive plate face toward a second magnet-conductive plate and stamping the first magnet-conductive plate and the second magnet-conductive plate to make the first magnet-conductive plate adhered to the second magnet-conductive plate via the glue.

2. The method for manufacturing a magnet-conductive device in accordance with claim 1, wherein the glue dispenser further includes a substrate having an accommodating slot, and the base is disposed into the accommodating slot of the substrate.

3. The method for manufacturing a magnet-conductive device in accordance with claim 2, wherein the first magnet-conductive plate comprises a bearing portion and a pre-moved portion located at outside of the bearing portion, the substrate further comprises a bearing surface, the bearing portion corresponds to the top surface of the base, the pre-moved portion corresponds to the bearing surface of the substrate, and the glue is adhered to the bearing portion of the first magnet-conductive plate.

4. The method for manufacturing a magnet-conductive device in accordance with claim 3, wherein the pre-moved portion of the first magnet-conductive plate contacts against the bearing surface of the substrate, the bearing surface of the substrate is higher than the top surface of the base, and the glue is higher than the bearing surface.

5. The method for manufacturing a magnet-conductive device in accordance with claim 1, wherein the adhering step includes stamping the first magnet-conductive plate by a stamping unit and making the first magnet-conductive plate adhered to the second magnet-conductive plate.

6. The method for manufacturing a magnet-conductive device in accordance with claim 5, wherein the stamping unit includes a stamping member and a molding base having a cavity, the first magnet-conductive plate comprises a bearing portion and a pre-moved portion, wherein the adhering step includes stamping the bearing portion of the first magnet-conductive plate by the stamping member and making the bearing portion separate apart from the pre-moved portion and fall into the cavity of the molding base to make the bearing portion adhered to the second magnet-conductive plate.

7. The method for manufacturing a magnet-conductive device in accordance with claim 5 further includes a feeding step after the filling step is performed, wherein the first magnet-conductive plate with the adhering glue is transmitted from the glue dispenser to the stamping unit by a feeder for performing the following adhering step.

8. An apparatus for manufacturing a magnet-conductive device includes:
a glue dispenser including a base having a top surface and a plurality of glue outlets located on the top surface; and
a stamping unit including a stamping member and a molding base having a cavity, the stamping member is located on top of the cavity.

9. The apparatus for manufacturing a magnet-conductive device in accordance with claim 8, wherein the glue dispenser further includes a substrate having an accommodating slot, and the base is disposed into the accommodating slot of the substrate.

10. The apparatus for manufacturing a magnet-conductive device in accordance with claim 9, wherein the substrate comprises a bearing surface higher than the top surface of the base.

11. The apparatus for manufacturing a magnet-conductive device in accordance with claim 8, wherein the base further comprises a suction hole located at the top surface.
